(19) United States
(12) Patent Application Publication
(10) Pub. No.: US 2025/0190522 A1
(43) Pub. Date: Jun. 12, 2025

(54) METHOD AND APPARATUS FOR OBTAINING LOWER TRIANGULAR MATRIX FOR MATRIX MULTIPLICATION RESULT VALUE

(71) Applicant: Electronics and Telecommunications Research Institute, Daejeon (KR)

(72) Inventor: Yeong Min Lee, Daejeon (KR)

(73) Assignee: Electronics and Telecommunications Research Institute, Daejeon (KR)

(21) Appl. No.: 18/973,538

(22) Filed: Dec. 9, 2024

(30) Foreign Application Priority Data
Dec. 11, 2023 (KR) 10-2023-0178788
Nov. 11, 2024 (KR) 10-2024-0158810

(51) Int. Cl. G06F 17/16; G06N 3/0455

(52) U.S. Cl. CPC G06F 17/16; G06N 3/0455

(57) ABSTRACT

A computer implementation method for obtaining a lower triangular matrix for a matrix multiplication result value, the method comprising: a process of allocating elements of each of a first operand matrix pair and a second operand matrix pair input into a memory to calculation units of an accelerator; and a process of the calculation units of the accelerator performing a matrix multiplication calculation on the elements of the first operand matrix pair and the second operand matrix pair, wherein the process of allocating the elements thereof to the calculation units of the accelerator comprises: allocating elements of the first operand matrix pair to first calculation units corresponding to elements of the lower triangular matrix for the matrix multiplication result value of the first operand matrix pair; and allocating elements of the second operand matrix pair to second calculation units corresponding to elements of the lower triangular matrix for the matrix multiplication result value of the second operand matrix pair.

### CROSS-REFERENCE TO RELATED APPLICATIONS

This application claims the benefit of and priority to Korean Patent Application No. 10-2023-0178788 filed on Dec. 11, 2023 and Korean Patent Application No. 10-2024-0158810 filed on Nov. 11, 2024, the entire disclosures of which are hereby incorporated herein by reference in their entireties.

### TECHNICAL FIELD

The present disclosure relates to a method and apparatus for obtaining a lower triangular matrix for a matrix multiplication result value. More specifically, the present disclosure relates to a method and apparatus for improving the efficiency of mask attention score calculation in a process of computing a mask attention score matrix of an artificial neural network based on a transformer structure.

### BACKGROUND

The description in this section merely provides background information related to the present disclosure and does not constitute the related art.

Artificial intelligence (AI) is a technology that allows computers to perform human-like intelligent tasks, and machine learning is a method of implementing the AI. Deep learning is a field of machine learning that effectively learns complex data by utilizing multilayer neural networks.

Transformer is one of the deep learning models in the field of natural language processing, and may process sequence data without a recurrent neural network (RNN) or convolutional neural network (CNN). The key is the technology that utilizes the attention mechanism to identify the relationship between each element in the input data. The transformer has an encoder-decoder structure and uses positional encoding to supplement the location information of the sequence. Multi-head attention allows multiple attention mechanisms to be performed in parallel to learn various patterns. The transformer shows excellent performance in various natural language processing tasks such as machine translation and summarization.

The training and inference processes of deep learning models involve large-scale matrix multiplication calculations. The matrix multiplication calculations require a large amount of calculations, and their calculation speed may affect the performance of the model. Matrix multiplication calculation acceleration modules are hardware or software solutions for efficiently processing matrix calculations. Hardware accelerators such as graphics processing units (GPUs) and tensor processing units (TPUs) use parallel processing to increase calculation speed, while software improves efficiency by improving calculation optimization algorithms or memory access methods. In particular, since the multi-head attention of transformers requires large-scale matrix multiplication calculations, the importance of acceleration modules is further emphasized.

### SUMMARY

A main aspect of the present disclosure is directed to providing a method and apparatus for improving the efficiency of matrix multiplication calculation in a process of calculating a mask attention score matrix of an artificial neural network based on a transformer structure.

The aspects of the present disclosure are not limited to those mentioned above, and other aspects not mentioned herein will be clearly understood by those skilled in the art from the following description.

According to an embodiment of the present disclosure, the efficiency of the calculation can be improved by replacing an inefficient zero calculation of an operand matrix in the matrix multiplication calculation of a mask multi-head attention score calculation process with a non-zero-valued element. More specifically, the efficiency of the matrix multiplication calculation can be improved by allocating data so as not to perform a calculation corresponding to a location to be masked in the future regardless of the element value of the operand matrix.

The benefits of the present disclosure are not limited to those mentioned above, and other benefits not mentioned may be clearly understood by those skilled in the art from the following description.

### BRIEF DESCRIPTION OF THE DRAWINGS

FIG. 1 is a diagram visualizing a general mask multi-head attention calculation process using a matrix multiplication acceleration module.

FIG. 2 is a diagram visualizing a calculation process utilizing a one-dimensional vector calculation acceleration module.

FIG. 3 is a block diagram illustrating an apparatus for improving the efficiency of mask attention score calculation in a process of calculating a mask multi-head attention score matrix according to an embodiment of the present disclosure.

FIG. 4 is a flowchart schematically showing a method for improving the efficiency of mask attention score calculation in a process of calculating a mask multi-head attention score matrix according to an embodiment of the present disclosure.

FIG. 5 is a diagram schematically illustrating a configuration of an exemplary computing device capable of being used to implement the apparatuses and methods described in an embodiment of the present disclosure.

### DETAILED DESCRIPTION

An embodiment of the present disclosure relates to a technology for improving the efficiency of a matrix multiplication calculator in a stage of generating a mask attention score matrix of an artificial neural network based on a transformer structure.

A transformer is one of the deep learning models in the field of natural language processing (NLP), and shows excellent performance in various tasks such as translation, summarization, and question-answering. Unlike recurrent neural networks or long short-term memory, the transformer does not require sequential processing, making it efficient for parallel processing. The transformer uses an attention mechanism to efficiently identify the relevance of each word in a sentence.

There are a total of four main structures of the transformer architecture: embedding, positional encoding, attention, and residual connection.

The embedding is a process of converting an input word into a high-dimensional vector. The input of the transformer is converted into a vector using an embedding layer that expresses the meaning of the word as a vector. For example, words such as “cat” and “dog” have the common characteristic of being animals, and thus may be placed in relatively close locations in a vector space.

The transformer is a structure that does not consider the order, and thus uses positional encoding to recognize the order of the input words. The positional encoding is a method of adding positional information to the input word vector, allowing the model to understand the relative location of each word. To this end, the positional encoding uses periodic signals based on a sine function and cosine function.

The residual connection is used to alleviate the problem that learning becomes difficult as the deep learning model becomes deeper. The transformer uses that residual connections that add inputs and outputs to each layer to increase learning stability and minimize information loss.

The attention is the core mechanism of the transformer. The attention computes how much each input word is associated with other words in a sentence to identify the context. The transformer uses self-attention and multi-head attention. The self-attention creates a vector that considers the context by interacting each word with other words in the sentence. The multi-head attention extracts context information from various perspectives by performing the self-attention multiple times.

Masked attention applies masking to prevent access to future information. Specifically, when learning a language model, the decoder needs to utilize only previous words to predict the next word. However, the general attention mechanism processes all inputs at once, and thus may see words after the current point in time, causing the problem of knowing future information in advance. Accordingly, the masked attention sets the weight for words in the future point in time to 0, preventing access to future information, and thus learning is performed so that the decoder may generate and predict sentences in a natural order.

The mathematical expression of the attention score is as shown in Equation 1.

$$Attention ( Q , K , V ) = softmax ( \frac{{QK}^{T}}{\sqrt{{d}_{k}}} ) V \qquad [ Equation 1 ]$$

Q (query) is a vector created from the information of the current word, and decides which word needs to be associated when identifying the context. K (key) is a vector containing information on all words, and contains the meaning of each word. V (value) is a vector containing actual information about each word, and is used when computing the weighted sum according to the attention score. \sqrt{dₖ} is a normalization constant, which is the dimension of the query and key. The softmax function converts the attention score into a probability distribution and computes the weight for each word. T represents the transposed matrix.

The attention score is computed using the inner product of Q and K. The attention score indicates the relevance of each word. After normalization by \sqrt{dₖ}, the probability distribution is generated by the softmax function. The probability distribution indicates how important each word is. Finally, V is multiplied to obtain the final attention result.

The mathematical expression of the multi-head attention score is as shown in Equation 2.

$$MultiHead ( Q , K , V ) = Concat ( {head}_{1} , {head}_{2} , … , {head}_{h} ) {W}^{O} \qquad [ Equation 2 ]$$

$${head}_{i} = Attention ( {Q}_{i} , {K}_{i} , {V}_{i} ) = softmax ( \frac{{Q}_{i} {K}_{i}^{T}}{\sqrt{{d}_{k}}} ) {V}_{i}$$

headᵢ is the result of each attention head, and each head independently performs attention on the query, key, and value. Qᵢ, Kᵢ, and Vᵢ are matrices of the query, key, and value, respectively, and are the results of multiplying the input token by the weight of each head. Concat concatenates the results of each head into one. W^{O} is the linear transformation weight applied to the final combined vector.

The multi-head attention uses a plurality of attention heads to interpret the input in different ways. Each head independently linearly transforms the query, key, and value. Each head may extract contextual information from various perspectives by performing its own attention calculation. The results of each head are concatenated to generate the final output vector, and linear transformation is performed thereon to utilize the same in a model.

The mathematical expression of the mask multi-head attention score is as shown in Equation 3.

$$Attention ( Q , K , V ) = softmax ( \frac{{QK}^{T}}{\sqrt{{d}_{k}}} ∘ M ) V \qquad [ Equation 3 ]$$

M is a mask matrix consisting of 0 or 1, and is applied by performing element-wise multiplication on the attention score. When the element of the mask is 1, the score at the corresponding location is maintained, and when the element of the mask is 0, the score is ignored and processed so as not to affect a softmax stage. By multiplying the mask, the attention mechanism is prevented from focusing on information that is not necessary.

An accelerator operation unit or accelerator refers to a hardware component or module designed to process a specific calculation quickly and efficiently. The accelerator is designed to provide much faster performance than a general CPU when complex calculations or large amounts of data need to be processed. The accelerator is mainly utilized for high-performance calculation tasks such as deep learning, scientific computations, data analysis, and signal processing.

In the case of matrix calculations for performing the calculations of Equations 1 to 3, a matrix multiplication accelerator may be used. The matrix multiplication accelerator refers to an apparatus that performs multiplication calculations between matrices of a given hardware as efficiently as possible. In particular, a matrix multiplication calculation is used very frequently in fields such as deep learning, and fast processing of the matrix multiplication calculation may greatly improve model learning and inference speed. Matrix multiplication is a calculation that multiplies two matrices A and B to produce a new matrix C, where each element is computed as the inner product between the rows of A and the columns of B. The matrix multiplication calculation involves repeated multiplication and addition between elements, and thus requires a large amount of calculation. Hence, the matrix multiplication calculation needs to be accelerated, and there are various ways to accelerate the same.

As a dedicated hardware accelerator, a graphics processing unit (GPU) is optimized for parallel processing of large-scale matrix calculations for graphics processing. The GPU may process large-scale matrix multiplication calculations simultaneously using thousands of small cores, and thus is mainly used for tasks such as deep learning. The Tensor Processing Unit (TPU) developed by Google is a dedicated hardware for deep learning calculations, and is specialized in matrix multiplication and vector calculations. The TPU is equipped with a matrix multiply unit (MMU) to quickly process large-scale matrix multiplication calculations. The matrix multiplication may be accelerated using a chip designed for a specific purpose (ASIC) or a programmable chip (FPGA). This method may optimize hardware for a specific task, so that the matrix multiplication calculations may be performed more quickly.

The calculation unit of the present disclosure refers to a single hardware component designed to perform specific computations. The calculation module of the present disclosure refers to a structure comprising multiple calculation units collectively configured to handle complex computational tasks.

A calculation unit may also be referred to as an Arithmetic Logic Unit (ALU), a Multiply-Accumulate Unit (MAC), or a Processing Unit. These terms are used interchangeably or to indicate similar concepts depending on the context and collectively encompass hardware components designed to perform specific computations.

The calculation unit of the present disclosure can be implemented as a transistor-based digital circuit capable of performing arithmetic and logical operations at the hardware level. For example, a calculation unit may internally include a register file for storing and accessing data, a gate array for processing computational logic, and a synchronization mechanism driven by clock signals. In another example, the calculation unit may be configured to operate independently while being interconnected in a network form to enable parallel processing with multiple units.

The computation of an amount of calculation according to an embodiment of the present disclosure may be expressed as the number of multiplication and accumulation (MAC), which is the most basic calculation type of hardware. No special calculation is required for memory access for data input/output. However, each load and store consumes a latency of at least 1 clock cycle, and thus may be expressed by substituting the same with a level equivalent to or lower than the MAC calculation (at least 1 clock cycle).

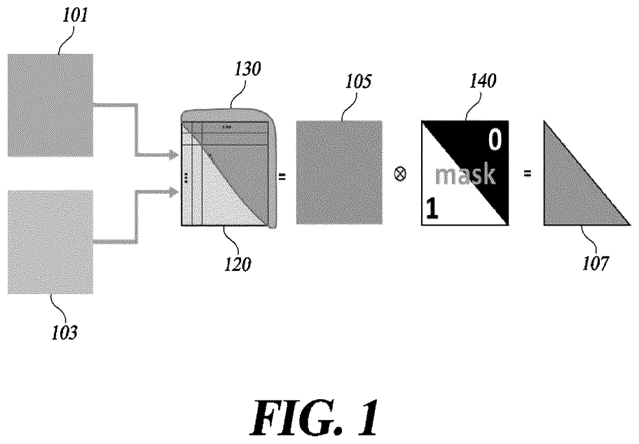

FIG. 1 is a diagram visualizing a general mask multi-head attention calculation process using a matrix multiplication acceleration module.

Referring to FIG. 1, a matrix multiplication acceleration module 120 receives a query matrix (Q) 101 and a key matrix (K) 103, calculates an attention matrix 105 as a result value, and then performs an element-wise multiplication of a mask matrix (M) 140 consisting of 0 and 1 to obtain a final mask attention matrix 107.

The method of FIG. 1 is a method capable of increasing the calculation parallelism of a method of managing and processing input and output data. However, since the method involves an unnecessary calculation 130 for calculating elements of the upper right diagonal matrix, there is an issue of reducing the overall efficiency of the artificial neural network calculation. The unnecessary calculation 130 means a calculation on information of a future point in time. That is, after all the multiplication calculations of the query matrix (Q) 101 and the key matrix (K) 103 are performed, the process of leaving only the information that is actually necessary by multiplying the mask matrix is performed. The upper right diagonal elements of the attention score matrix before multiplying the mask matrix are meaningless values, and unnecessary calculations are performed.

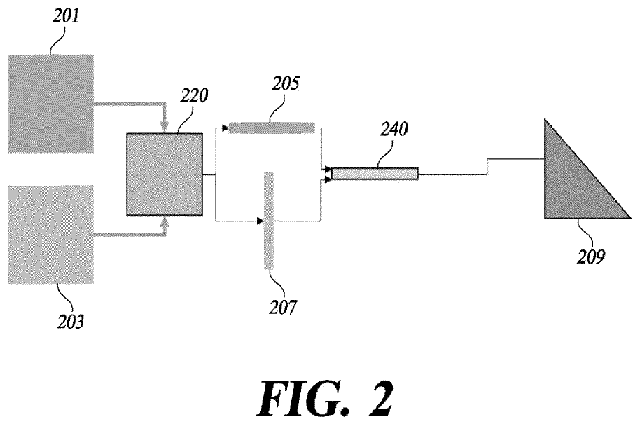

FIG. 2 is a diagram visualizing a calculation process utilizing a one-dimensional vector calculation acceleration module.

Referring to FIG. 2, a specific row of a query matrix (Q) 201 and a specific column (one-dimensional vector) of a key matrix (K) 203 are selected and separated 220. The matrix multiplication calculation is performed on extracted one-dimensional vectors 205, 207 using a vector engine acceleration module 240. This is a method of computing only the elements necessary for the calculation of the attention score matrix and putting the same into a mask attention matrix 209.

The method of FIG. 2 may significantly reduce the amount of calculation by utilizing vector calculation instead of performing the entire matrix multiplication calculation, thereby computing only the necessary portion. However, since the input is sequentially input to an vector engine, the calculation parallelization efficiency decreases.

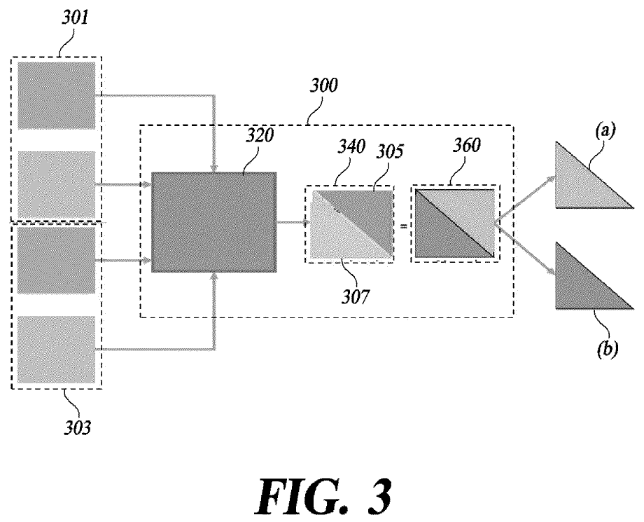

FIG. 3 is a block diagram illustrating an apparatus for improving the efficiency of mask attention score calculation in a process of calculating a mask multi-head attention score matrix according to an embodiment of the present disclosure.

Referring to FIG. 3, an apparatus 300 for improving the efficiency of matrix multiplication calculation according to an embodiment of the present disclosure may include a data collection and allocation module 320, a matrix multiplication calculation acceleration module 340, and a calculation result separation module 360.

The data collection and allocation module 320 performs the role of allocating input data to a calculator, and for example, may be configured of a memory interface for temporarily storing and retrieving input data, a data routing module for controlling data flow and distributing the same to an appropriate location, distribution logic for managing data selection and allocation, a register that acts as a cache and temporary storage for fast data access, and a control unit for managing the overall data flow and communicating with the calculator.

The data collection and allocation module 320 collects data as input values for query matrices (Q₁, Q₂, . . . ) and key matrices (K₁, K₂, . . . ) of two or more heads and performs a data allocation process for inputting the next stage.

In order to reduce unnecessary calculations of matrix multiplication calculations, the data allocation process allocates the operand matrix of the query and key of head 1 301 to a calculator 307 located at the lower left of the matrix multiplication calculation acceleration module (Matmul engine) 340, and allocates the operand matrix of the query and key of head 2 303 to a calculator 305 located at the upper right. The values in the upper right of the diagonal of the matrix of the multi-head attention score calculation result are not necessary for the final calculation. In other words, since only the elements of the lower triangular matrix for the result of the attention score calculation are required, the data allocation process may ultimately reduce the amount of calculation by eliminating unnecessary calculation processes in the future. In other words, the data allocation process is a method of improving the efficiency of the calculation by replacing the zero calculation of the operand matrix of the matrix multiplication calculation with a non-zero-value element. By allocating data so that the calculation corresponding to the location to be masked in the future is not performed regardless of the element value of the operand matrix, the efficiency of the matrix multiplication calculation may be expected to be improved. In other words, the data allocation process is an omission of the process of multiplying M in Equation 3.

The data collection and allocation module 320 loads data (Q, K) from an input memory and stores the same in an appropriate address of another memory space. That is, referring to FIG. 3, since the operation of loading and storing all elements of four N-by-N matrices (Q₁, K₁ 310 and Q₂, K₂ 303) is performed, at least 4*N*N*2 of the amount of calculation is required.

Equation 4 is an equation for explaining the matrix multiplication calculation of the process of computing the mask multi-head attention score matrix according to an embodiment of the present disclosure with a specific example.

$$Q 1 = [ \begin{matrix}q 1 & q 2 \\ q 3 & q 4\end{matrix} ] , K 1 = [ \begin{matrix}k 1 & k 2 \\ k 3 & k 4\end{matrix} ] \qquad [ Equation 4 ]$$

$$Q 2 = [ \begin{matrix}q 5 & q 6 \\ q 7 & q 8\end{matrix} ] , K 2 = [ \begin{matrix}k 5 & k 6 \\ k 7 & k 8\end{matrix} ]$$

The matrix pair of the query and key 301 of head 1 is defined as Q1 and K1, and the matrix pair of the query and key 303 of head 2 is defined as Q2 and K2.

Referring to Equation 4, the data collection and allocation module 320 allocates each of the elements q1, q2, q3, q4, k1, k2, k3, k4 for calculating

$$[ \begin{matrix}q 1 * k 1 + q 2 * k 3 & 0 \\ q 3 * k 1 + q 4 * k 3 & q 3 * k 2 + q 4 * k 4\end{matrix} ]$$

to the calculator 307 located at the lower left of the matrix multiplication calculation acceleration module 340 corresponding to the lower triangular matrix for the matrix multiplication result value of the matrix pair of head 1.

Each of the elements q1, q2, q3, q4, k1, k2, k3, k4 is allocated for calculating

$$[ \begin{matrix}q 5 * k 5 + q 6 * k 7 & \\ q 7 * k 5 + q 8 * k 7 & q 7 * k 6 + q 8 * k 8\end{matrix} ]$$

to the calculator 305 located at the upper right of the matrix multiplication calculation acceleration module 340 corresponding to the lower triangular matrix for the matrix multiplication result value of the matrix pair of head 2. As a result, the units of the calculator may be utilized efficiently.

The amount of calculation of the aforementioned calculation process requires an amount of calculation of 4*N*N*2 due to loading and storing operations for all elements when the operand matrix is 2 by 2. Therefore, the amount of calculation may be said to be 4*2*2*2.

Although the form of the calculator 305, 307 in the matrix multiplication calculation acceleration module 340 of FIG. 3 is illustrated as a form in which an upper triangular matrix and a lower triangular matrix are combined, an embodiment of the present disclosure is not limited thereto. The form of the calculator is unrelated to the form of the operand matrix. The allocation of data may be divided into various forms depending on the size of a calculation unit and a data processing method. For example, in the case of multiplication between N by N matrices, the acceleration calculator corresponding to the multiplication calculation does not need to be in the form of N by N. In addition, the allocation of the acceleration calculator corresponding to the merged attention matrix, which allocates all elements of the lower triangular matrix (N by N) to each matrix multiplication result value of head 1 and head 2, does not need to be (N+1) by N or N by (N+1).

The matrix multiplication calculation acceleration module 340 includes various components for efficiently processing complex mathematical calculations. For example, the matrix multiplication calculation acceleration module 340 may be configured of a calculation unit (ALU, FMA, vector/matrix multiplication unit), a register and buffer for high-speed data access, logic for data placement and calculation order management, a MAC for performing the core calculation of matrix multiplication, a cache and a memory interface for communicating with an external memory and storing data in the cache, and a control unit for overall control of an calculation process.

The matrix multiplication calculation acceleration module 340 performs a general matrix multiplication calculation based on the input data to compute the merged attention matrix. Some elements 307 of the merged attention matrix correspond to elements of head 1 301, and the remaining elements 305 correspond to elements of head 2 303.

The matrix multiplication calculation acceleration module 340 requires a minimum amount of calculation of N*N*N since the amount of calculation is matrix multiplication for N by N matrices. The hardware accelerator occupies resources for processing all calculations in parallel and operates in batches.

Referring to Equation 4, q1*k1+q2*k3, q3*k1+q4*k3, q3*K2+q4*k4 allocated to the calculator 307 of the matrix multiplication calculation acceleration module 340 is calculated, and q5*k5+q6*k7, q7*k5+q8*k7, q7*k6+q8*k8 allocated to the calculator 305 is calculated.

The amount of calculation of the aforementioned calculation process is a multiplication of an N by N matrix, so an amount of calculation of N*N*N is required. Since the operand matrix is 2 by 2, the amount of calculation may be said to be 2*2*2. The hardware accelerator occupies resources for processing all calculations in parallel and operates in batches.

The calculation result separation module 360 separates the mask attention matrix of each head and stores the same in a memory and storage device in order to perform the next stage calculation. That is, the calculation result separation module 360 is separated by the head that was initially input in the form of a lower triangular matrix, which is the result of the mask attention score calculation. The calculation result separation module 360 loads each element of the merged attention matrix (N-by-N matrix) and stores the same in a different memory space, so at least two memory accesses (calculations) are consumed for each element. In other words, an amount of calculation of 2*N*N is required.

Referring to Equation 4, FIG. 3(b), which shows a separation of the element of the lower triangular matrix of the matrix multiplication result value of head 1 of the calculation result separation module 360 into the form of the lower triangular matrix, is the same as

$$[ \begin{matrix}q 1 * k 1 + q 2 * k 3 & \\ q 3 * k 1 + q 4 * k 3 & q 3 * k 2 + q 4 * k 4\end{matrix} ] .$$

FIG. 3(a), which shows a separation of the element of the lower triangular matrix of the matrix multiplication result value of head 2 into the form of the lower triangular matrix, is the same as.

$$[ \begin{matrix}q 5 * k 5 + q 6 * k 7 & \\ q 7 * k 5 + q 8 * k 7 & q 7 * k 6 + q 8 * k 8\end{matrix} ] .$$

This is the result of separating the lower triangular matrix for the multiplication result value of the operand matrix pair of each head from the merged attention matrix. As a result, the mask attention score matrix for each head was calculated.

The amount of calculation of the aforementioned calculation process is an operation of loading each element of the merged attention matrix and storing the same in a different memory space, so two memory accesses are consumed for each element. In other words, when the operand matrix is N by N, an amount of calculation of 2*N*N is required. Accordingly, the amount of calculation may be said to be 2*2*2.

The amount of calculation of a general mask multi-head attention calculation process requires an amount of calculation of 2*N*N*N when the operand matrix is N by N, assuming that the data collection and allocation module 320 and the calculation result separation module 360 operate on the input matrix of each head (two heads) since there is no calculation process.

However, in an embodiment according to the present disclosure, compared to the general multi-head attention score calculation process, even though the calculation process of the data collection and allocation module 320 and the calculation result separation module 360 have been added, according to Table 1, the amount of calculation is reduced for matrices larger than 16 by 16.

TABLE 1

| | Amount of calculation according to an embodiment of | | | | | |
|---|---|---|---|---|---|---|
| | the present disclosure | | | | | |
| | Amount of | Amount of | Amount of | | | |
| | calculation | calculation of | calculation | | | |
| | of data | matrix | of | | | |
| | collection | multiplication | calculation | | | Comparison of |
| | and | calculation | result | | General amount | amount of |
| Matrix | allocation | acceleration | separation | | of calculation | calculation |
| size N | module | module | module | Total(A) | Total(B) | (=A/B*100%) |
| 4 | 128 | 64 | 32 | 224 | 128 | 175% |
| 8 | 512 | 512 | 128 | 11152 | 1024 | 113% |
| 16 | 2048 | 4096 | 512 | 6656 | 8192 | 81% |
| 32 | 8192 | 32768 | 2048 | 43008 | 65536 | 66% |
| 64 | 32768 | 262144 | 8192 | 30104 | 524288 | 58% |
| 128 | 131072 | 2097152 | 32768 | 2260992 | 4194304 | 54% |
| 256 | 524288 | 16777216 | 131072 | 17432576 | 33554432 | 52% |
| 512 | 2097152 | 1342177287 | 524288 | 136839168 | 268435456 | 51% |
| 1024 | 8388608 | 1.074E+09 | 2097152 | 1084227584 | 2147483648 | 50% |

Since the conventional transformer uses a matrix of hundreds or thousands of sizes, an embodiment of the present disclosure has the benefit of reducing the amount of calculation by up to 50% compared to the conventional one.

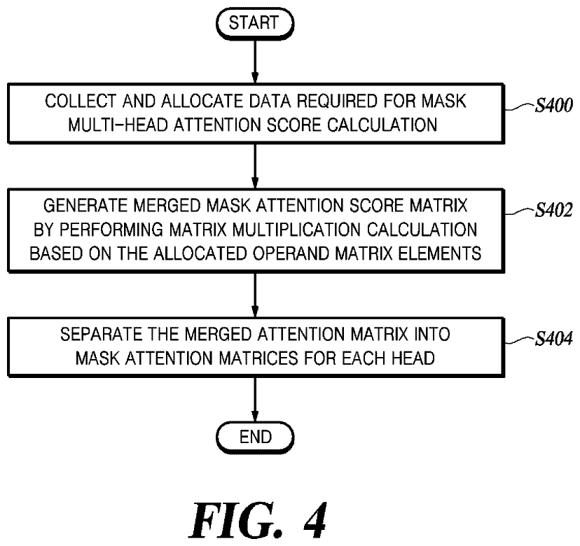

FIG. 4 is a flowchart schematically showing a method for improving the efficiency of mask attention score calculation in a process of calculating a mask multi-head attention score matrix according to an embodiment of the present disclosure.

The data collection and allocation module 320 loads data required for mask multi-head attention score calculation from the input memory and stores the same in an appropriate address of another memory space, thereby collecting and allocating data (S400). For example, the data collection and allocation module 320 collects data of pairs of query and key matrices of two or more heads and performs a data allocation process for input of the next stage. In order to reduce unnecessary calculations in a process of performing a matrix multiplication calculation, an element of an operand matrix is allocated to the calculator corresponding to a lower triangular matrix for a matrix multiplication result value of a query and key matrix pair of head 1 301, and an element of an operand matrix is allocated to the calculator corresponding to a lower triangular matrix for a matrix multiplication result value of a query and key matrix pair of head 2 303.

The matrix multiplication calculation acceleration module 340 performs a matrix multiplication calculation based on the elements of the allocated operand matrix. A general matrix multiplication calculation is performed based on the allocated elements to generate a mask attention matrix in which the elements of the lower triangular matrix for the operand matrix pair calculation result value of head 1 301 and the elements of the lower triangular matrix for the operand matrix pair calculation result value of head 2 303 are merged (S402).

The calculation result separation module 360 separates the merged mask attention matrix into mask attention matrices for each head and stores the same in the memory and storage devices (S404). Herein, the mask attention matrix for each head is separated into the form of a lower triangular matrix. This is to perform the next stage of calculation in a future.

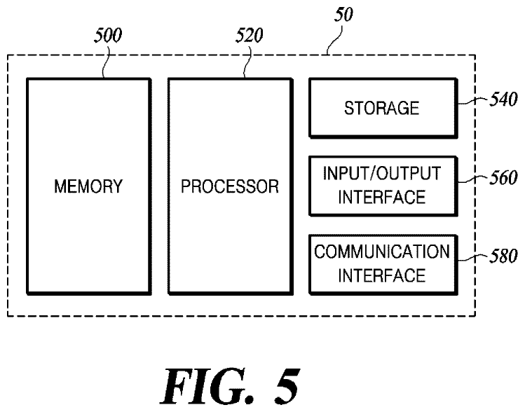

FIG. 5 is a diagram schematically illustrating a configuration of an exemplary computing device capable of being used to implement the apparatuses and methods described in an embodiment of the present disclosure.

A computing device 50 may include all or part of a memory 500, a processor 520, storage 540, an input/output interface 560, and a communication interface 580. The computing device 50 may be a stationary computing device, such as a desktop computer or a server, as well as a mobile computing device, such as a laptop computer or a smartphone. The computing device 50 may include any specialized hardware accelerator capable of processing calculations for an artificial intelligence model in an efficient manner. For example, the computing device 50 may include a graphic processing unit (GPU), a tensor processing unit (TPU), or a neural processing unit (NPU).

The memory 500 may store a program that causes the processor 520 to perform a method or operation according to various embodiments of the present disclosure. For example, the program may include a plurality of commands executable by the processor 520, and the above-described method or operation may be performed by executing the plurality of commands by the processor 520. The memory 500 may be a single memory or a plurality of memories. In this connection, information required to perform the method or operation according to various embodiments of the present disclosure may be stored in a single memory or may be divided and stored in a plurality of memories. When the memory 500 is configured of a plurality of memories, the plurality of memories may be physically separated. The memory 500 may include at least one of a volatile memory and a non-volatile memory. The volatile memory may include a static random access memory (SRAM) or a dynamic random access memory (DRAM), and the non-volatile memory may include a flash memory, and the like.

The processor 520 may include at least one core capable of executing at least one command. The processor 520 may execute commands stored in the memory 500. The processor 520 may be a single processor or multiple processors.

The storage 540 maintains stored data even when power supplied to the computing device 50 is cut off. For example, the storage 540 may include non-volatile memory, and may include storage media such as magnetic tape, optical disk, or magnetic disk. The program stored in the storage 540 may be loaded into the memory 500 before being executed by the processor 520. The storage 540 may store a file written in a program language, and a program generated from the file by a compiler or the like may be loaded into the memory 500. The storage 540 may store data to be processed by the processor 520 and/or data processed by the processor 520.

The input/output interface 560 may provide an interface with an input device such as a keyboard, a mouse, etc., and/or an output device such as a display device, a printer, etc. A user may trigger execution of a program by the processor 520 through an input device and/or check the processing result of the processor 520 through an output device.

The communication interface 580 may provide access to an external network. The computing device 50 may communicate with other devices through the communication interface 580.

At least some of the components described in the exemplary embodiments of the present disclosure may be implemented as hardware elements including at least one or a combination of a digital signal processor (DSP), a processor, a controller, an application specific integrated circuit (ASIC), a programmable logic device (such as FPGA, etc.), and other electronic devices. In addition, at least some of the functions or processes described in the exemplary embodiments may be implemented in software, and the software may be stored in a recording medium. At least some of the components, functions, and processes described in the exemplary embodiments of the present disclosure may be implemented as a combination of hardware and software.

The method according to exemplary embodiments of the present disclosure may be written as a program executable on a computer, and may also be implemented in various recording media such as a magnetic storage medium, an optical readable medium, a digital storage medium, etc.

The implementations of the various technologies described herein may be implemented as digital electronic circuitry, or as computer hardware, firmware, software, or combinations thereof. The implementations may be implemented as a computer program product, in other words, a computer program tangibly embodied in an information carrier, for example, a machine-readable storage medium (computer-readable medium) or a radio signal, for processing by the operation of a data processing device, for example, a programmable processor, a computer, or a plurality of computers, or for controlling the operation thereof. A computer program, such as the computer program(s) described above, may be written in any form of programming language, including compiled or interpreted languages, and may be deployed in any form, including as a stand-alone program or as a module, component, subroutine, or other unit suitable for use in a computing environment. The computer program may be deployed to be processed on one computer or a plurality of computers at one site, or distributed across a plurality of sites and interconnected by a communications network.

Processors suitable for processing a computer program include, for example, both general-purpose and special-purpose microprocessors, and any one or more processors of any type of digital computer. In general, the processor will receive instructions and data from a read-only memory or a random access memory or both. Elements of the computer may include at least one processor for executing instructions and one or more memory devices for storing instructions and data. In general, a computer may include one or more mass storage devices for storing data, such as magnetic, magneto-optical disks, or optical disks, or may be coupled to receive data from, transmit data to, or both. Information carriers suitable for embodying computer program instructions and data include, by way of example, semiconductor memory devices, magnetic media such as hard disks, floppy disks, and magnetic tape, optical media such as CD-ROMs (Compact Disk Read Only Memory) and DVDs (Digital Video Disk), magneto-optical media such as floptical disks, ROMs (Read Only Memory), RAMs (Random Access Memory), flash memory, EPROMs (Erasable Programmable ROM), EEPROMs (Electrically Erasable Programmable ROM), etc. The processor and memory may be supplemented by, or included in, special purpose logic circuitry.

The processor may execute an operating system and software applications running on the operating system. In addition, a processor device may access, store, manipulate, process, and generate data in response to the execution of the software. For ease of understanding, the processor device is described as being used alone, but those skilled in the art will recognize that the processor device may include a plurality of processing elements and/or a plurality of types of processing elements. For example, the processor device may include a plurality of processors or one processor and one controller. In addition, other processing configurations, such as parallel processors, are also possible.

In addition, non-transitory computer-readable media may be any available media that may be accessed by a computer, and may include both computer storage media and transmission media.

What is claimed is:

1. A computer implementation method for obtaining a lower triangular matrix for a matrix multiplication result value, the method comprising:
a process of allocating elements of each of a first operand matrix pair and a second operand matrix pair input into a memory to calculation units of an accelerator; and
a process of the calculation units of the accelerator performing a matrix multiplication calculation on the elements of the first operand matrix pair and the second operand matrix pair,
wherein the process of allocating the elements thereof to the calculation units of the accelerator comprises:
allocating elements of the first operand matrix pair to first calculation units corresponding to elements of the lower triangular matrix for the matrix multiplication result value of the first operand matrix pair; and
allocating elements of the second operand matrix pair to second calculation units corresponding to elements of the lower triangular matrix for the matrix multiplication result value of the second operand matrix pair.

2. The method of claim 1, wherein:
each matrix of the first operand matrix pair and the second operand matrix pair is in the form of N by N;
the accelerator comprises calculation units arranged in the form of N by (N+1) or (N+1) by N; and
the first calculation units and the second calculation units are included in the calculation units arranged in the form of the N by (N+1) or (N+1) by N.

3. The method of claim 2, wherein the first calculation units and the second calculation units are units arranged in the form of an upper triangular matrix or a lower triangular matrix of the N by N matrix.

4. The method of claim 1, wherein further comprising a process of separating result values of the matrix multiplication calculation performed by the first calculation units and the second calculation units into lower triangular matrices having the same elements and forms as the lower triangular matrices of the result values of the matrix multiplication calculation of the first operand matrix pair and the second operand matrix pair.

5. The method of claim 1, wherein the method is applied as a mask attention score calculation method in a process of computing a mask multi-head attention score matrix in an artificial neural network based on a transformer structure.

6. The method of claim 5, wherein the first operand matrix pair and the second operand matrix pair are matrix pairs of different heads, respectively.

7. The method of claim 5, wherein the first operand matrix pair and the second operand matrix pair are matrix pairs of a query and a key, respectively.

8. An apparatus for obtaining a lower triangular matrix for a matrix multiplication result value, the apparatus comprising:
at least one memory storing instructions; and at least one processor, wherein the at least one processor executes the instructions to:
allocate elements of each of a first operand matrix pair and a second operand matrix pair input into a memory to calculation units of an accelerator; and
perform, by the calculation units of the accelerator, a matrix multiplication calculation on the elements of the first operand matrix pair and the second operand matrix pair,
wherein the process of allocating the elements thereof to the calculation units of the accelerator comprises:
allocating elements of the first operand matrix pair to first calculation units corresponding to elements of the lower triangular matrix for the matrix multiplication result value of the first operand matrix pair; and
allocating elements of the second operand matrix pair to second calculation units corresponding to elements of the lower triangular matrix for the matrix multiplication result value of the second operand matrix pair.

9. The apparatus of claim 8, wherein:
each matrix of the first operand matrix pair and the second operand matrix pair is in the form of N by N;
the accelerator comprises calculation units arranged in the form of N by (N+1) or (N+1) by N; and
the first calculation units and the second calculation units are included in the calculation units arranged in the form of the N by (N+1) or (N+1) by N.

10. The apparatus of claim 9, wherein the first calculation units and the second calculation units are units arranged in the form of an upper triangular matrix or a lower triangular matrix of the N by N matrix.

11. The apparatus of claim 8, wherein further performing a process of separating result values of the matrix multiplication calculation performed by the first calculation units and the second calculation units into lower triangular matrices having the same elements and forms as the lower triangular matrices of the result values of the matrix multiplication calculation of the first operand matrix pair and the second operand matrix pair.

12. The apparatus of claim 8, wherein the method is applied as a mask attention score calculation method in a process of computing a mask multi-head attention score matrix in an artificial neural network based on a transformer structure.

13. The apparatus of claim 12, wherein the first operand matrix pair and the second operand matrix pair are matrix pairs of different heads, respectively.

14. The apparatus of claim 12, wherein the first operand matrix pair and the second operand matrix pair are matrix pairs of a query and a key, respectively.
